(19) United States
(12) Patent Application Publication
(10) Pub. No.: US 2023/0237427 A1
(43) Pub. Date: Jul. 27, 2023

(54) SCAN BASED PACKAGING CONTROLLER

(71) Applicant: SAP SE, Waldorf (DE)

(72) Inventors: Ravish Kumar Ojha, Bangalore (IN); Ramkumar Sethurao, Bangalore (IN); Sanath Kumar K S, Bangalore (IN)

(21) Appl. No.: 17/669,913

(22) Filed: Feb. 11, 2022

(30) Foreign Application Priority Data
Jan. 24, 2022 (IN) 202211003886

(51) Int. Cl. G06Q 10/08; G06K 7/14; G06K 7/10

(52) U.S. Cl. CPC G06Q 10/087; G06K 7/1417; G06K 7/10386

(57) ABSTRACT

A method may include receiving, from a scanning device, a first scan of a first identifier of a first slot within a package unit or a first item to be disposed within the package unit. A correct item to be disposed within the first slot having the first identifier or a correct slot for receiving the first item having the first identifier may be determined based on the first identifier and a packing order associated with the package unit. A user interface may be generated to display an indication of the correct item to be disposed within the first slot having the first identifier or the correct slot for receiving the first item having the first identifier. Whether the correct item is disposed within the first slot or the first item is dispose within the correct slot may be determined based on a third scan of a third identifier.

### CROSS-REFERENCE TO RELATED APPLICATION

The present application claims priority to Indian Provisional Patent Application No. 202211003886, filed Jan. 24, 2022, and entitled “SCAN BASED PACKAGING CONTROLLER,” and incorporates its disclosure herein by reference in its entirety.

### FIELD

The present disclosure generally relates to manufacturing and inventory control and more specifically to a scan based packaging controller.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Data associated with multiple enterprise software applications may be stored in a common database in order to enable a seamless integration between different enterprise software applications. For example, an enterprise resource planning (ERP) application may track resources, such as cash, raw materials, and production capacity, and the status of various commitments such as purchase order and payroll. In the event the enterprise interacts with large and evolving roster of external vendors, the enterprise resource planning (ERP) application may be integrated with a supplier lifecycle management (SLM) application configured to perform one or more of supplier identification, selection and segmentation, onboarding, performance management, information management, risk management, relationship management, and offboarding.

### SUMMARY

Methods, systems, and articles of manufacture, including computer program products, are provided for scan based packaging. In one aspect, there is provided a system. The system may include at least one data processor and at least one memory. The at least one memory may store instructions that result in operations when executed by the at least one data processor. The operations may include: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

In some variations, one or more of the features disclosed herein including the following features can optionally be included in any feasible combination. The operations may further include: identifying, based at least the first identifier or a second identifier of the packaging unit included in a second scan received from the scanning device, the packing order for the package unit.

In some variations, the operations may further include: determining, based at least on one or more user inputs, a packing strategy for the package unit.

In some variations, the operations may further include: in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier.

In some variations, the operations may further include: receiving, from the scanning device, a second scan of a second identifier of a second item disposed within the first slot; determining, based at least on the packing order and the second identifier of the second item, whether the correct item is disposed within the first slot having the first identifier; and in response to the second item being an incorrect item for the first slot having the first identifier, updating the user interface to display an error message.

In some variations, the operations may further include: in response to the packing strategy being a material-by-material packing strategy, determining, based at least on the first identifier of the first item, the correct slot for receiving the first item having the first identifier, and generating the user interface to display the indication of the correct slot for receiving the first item having the first identifier.

In some variations, the operations may further include: receiving, from the scanning device, a second scan of a second identifier of a second slot in which the first item is disposed; determining, based at least on the packing order and the second identifier of the second slot, whether the first item having the first identifier is disposed within the correct slot; and in response to the first item having the first identifier being disposed with in an incorrect slot, updating the user interface to display an error message.

In some variations, the operations may further include: determining whether the package unit includes one or more additional slots for receiving a same item; and in response to the package unit including one or more additional slots for receiving the same item, receiving, from the scanning device, a second scan of a second identifier of a second item to be disposed within the package unit.

In some variations, the first identifier may include one or more of a Quick Response (QR) code, a stock keeping unit (SKU) code, a barcode, and a radio frequency identification (RFID) tag.

In some variations, the scanning device may include one or more of a barcode reader, a radio frequency identification (RFID) reader, a smartphone, a tablet computer, a wearable apparatus, a virtual assistant, and an Internet-of-Things (IoT) appliance.

In some variations, the operations may further include: in response to the correct item being disposed within the first slot having the first identifier or the first item being disposed within the correct slot, updating the user interface to provide an indication of a progress of packing the package unit.

In another aspect, there is provided a method for scan based packaging. The method may include: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

In some variations, one or more of the features disclosed herein including the following features can optionally be included in any feasible combination. The method may further include: identifying, based at least the first identifier or a second identifier of the packaging unit included in a second scan received from the scanning device, the packing order for the package unit.

In some variations, the method may further include: determining, based at least on one or more user inputs, a packing strategy for the package unit.

In some variations, the method may further include: in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier; receiving, from the scanning device, a second scan of a second identifier of a second item disposed within the first slot; determining, based at least on the packing order and the second identifier of the second item, whether the correct item is disposed within the first slot having the first identifier; and in response to the second item being an incorrect item for the first slot having the first identifier, updating the user interface to display an error message.

In some variations, the method may further include: in response to the packing strategy being a material-by-material packing strategy, determining, based at least on the first identifier of the first item, the correct slot for receiving the first item having the first identifier, and generating the user interface to display the indication of the correct slot for receiving the first item having the first identifier; receiving, from the scanning device, a second scan of a second identifier of a second slot in which the first item is disposed; determining, based at least on the packing order and the second identifier of the second slot, whether the first item having the first identifier is disposed within the correct slot; and in response to the first item having the first identifier being disposed with in an incorrect slot, updating the user interface to display an error message.

In some variations, the method may further include: determining whether the package unit includes one or more additional slots for receiving a same item; and in response to the package unit including one or more additional slots for receiving the same item, receiving, from the scanning device, a second scan of a second identifier of a second item to be disposed within the package unit.

In some variations, the first identifier may include one or more of a Quick Response (QR) code, a stock keeping unit (SKU) code, a barcode, and a radio frequency identification (RFID) tag. The scanning device may include one or more of a barcode reader, a radio frequency identification (RFID) reader, a smartphone, a tablet computer, a wearable apparatus, a virtual assistant, and an Internet-of-Things (IoT) appliance.

In some variations, the method may further include: in response to the correct item being disposed within the first slot having the first identifier or the first item being disposed within the correct slot, updating the user interface to provide an indication of a progress of packing the package unit.

In another aspect, there is provided a computer program product that includes a non-transitory computer readable storage medium. The non-transitory computer-readable storage medium may include program code that causes operations when executed by at least one data processor. The operations may include: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a scan based packaging controller, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a network diagram illustrating a scan based packaging system, in accordance with some example embodiments;

FIG. 2A depicts a schematic diagram illustrating an example of a package unit, in accordance with some example embodiments;

FIG. 2B depicts a schematic diagram illustrating another example of a package unit, in accordance with some example embodiments;

FIG. 2C depicts a schematic diagram illustrating another example of a package unit, in accordance with some example embodiments;

FIG. 2D depicts a schematic diagram illustrating an example of a production sequence, in accordance with some example embodiments;

FIG. 3A depicts a flowchart illustrating an example of a process for scan based packaging, in accordance with some example embodiments;

FIG. 3B depicts a flowchart illustrating another example of a process for scan based packaging, in accordance with some example embodiments; and

FIG. 4A depicts a screenshot of an example of a user interface, in accordance with some example embodiments;

FIG. 4B depicts a screenshot of another example of a user interface, in accordance with some example embodiments;

FIG. 5 depicts a block diagram illustrating an example of a computing system, in accordance with some example embodiments.

When practical, like labels are used to refer to same or similar items in the drawings.

### DETAILED DESCRIPTION

Enterprise software applications may provide a variety of procurement and supply chain management solutions including enterprise resource planning (ERP) and supplier lifecycle management (SLM). For example, an enterprise resource planning (ERP) system may integrate with one or more scanning devices (e.g., barcode readers and/or the like) such that the movement of goods through the supply chain may be tracked by scanning one or more identifiers affixed to the goods. Examples of scannable identifiers include a Quick Response (QR) code, a stock keeping unit (SKU) code, a barcode, and a radio frequency identification (RFID) tag. Although the presence of scannable identifiers render the goods traceable, the packing order of goods remain largely haphazard because conventional packaging processes do not integrate scannable identifiers in an efficient manner. This despite significant benefits to both suppliers and consumers when goods are packaged in an orderly fashion. For instance, packaging components in the order in which the components are used during subsequent assembly may reduce inventory and increase production efficiency.

As such, in some example embodiments, a scan based packaging controller may be configured to impose an order for packaging items into a package unit. The package unit may include multiple slots, each of which being configured to receive a particular item. For example, the package unit may include a first identifier associated with a packing order such that upon receiving, from a scanning device, the first identifier, the packaging controller may identify the packing order associated with the package unit. Meanwhile, each slot in the package unit and/or the corresponding item may also include an identifier. Accordingly, upon receiving, from the scanning device, a second identifier of a slot in the package unit, the packaging controller may identify, based at least on the packing order associated with the package unit, the item that is to be disposed within the slot. Alternatively and/or additionally, upon receiving, from the scanning device, a third identifier of an item, the packaging controller may identify, based at least on the packing order associated with the package unit, a slot in the package unit for receiving the item. The packaging controller may generate, for example, for display at the scanning device, a user interface identifying the slot and/or the item. Moreover, in some instances, the packaging controller may determine, based at least on the second identifier of the slot and the third identifier of the item, whether the item is disposed in the correct slot in the package unit.

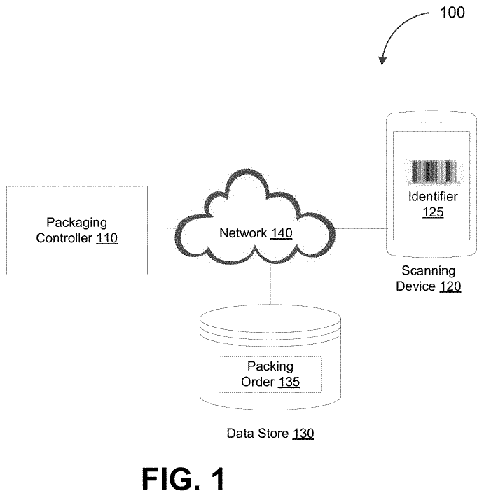

FIG. 1 depicts a system diagram illustrating an example of a scan based packaging system 100, in accordance with some example embodiments. Referring to FIG. 1, the scan based packaging system 100 may include a packaging controller 110, a scanning device 120, and a data store 130. The packaging controller 110, the scanning device 120, and the data store 130 may be communicatively coupled via a network 140. The scanning device 120 may be any device capable of capturing an identifier such as a Quick Response (QR) code, stock keeping unit (SKU) code, a barcode, a radio frequency identification (RFID) tag, and/or the like. Examples of the scanning device 120 include a barcode reader, a radio frequency identification (RFID) reader, a smartphone, a tablet computer, a wearable apparatus, a virtual assistant, an Internet-of-Things (IoT) appliance, and/or the like. The data store 130 may include a variety of data repositories such as, for example, a relational database, a graph database, an in-memory database, a non-SQL (NoSQL) database, a key-value store, a document store, and/or the like. The network 140 may be a wired network and/or a wireless network including, for example, a wide area network (WAN), a local area network (LAN), a virtual local area network (VLAN), a public land mobile network (PLMN), the Internet, and/or the like.

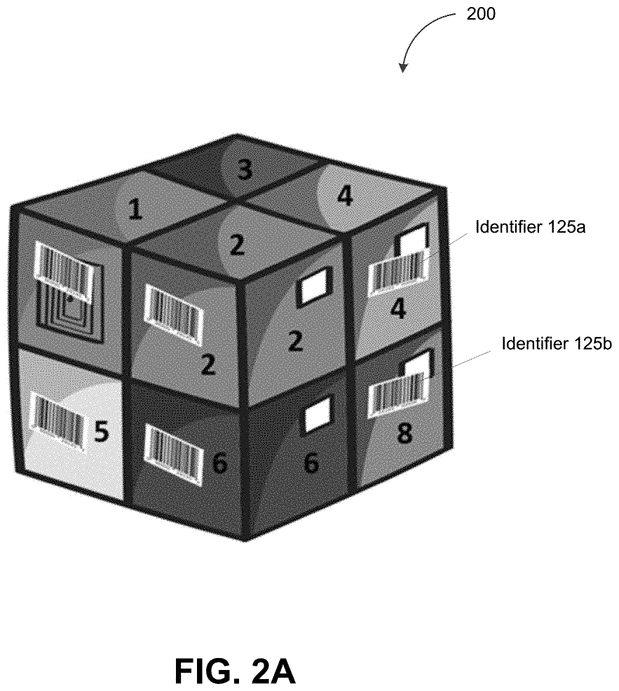

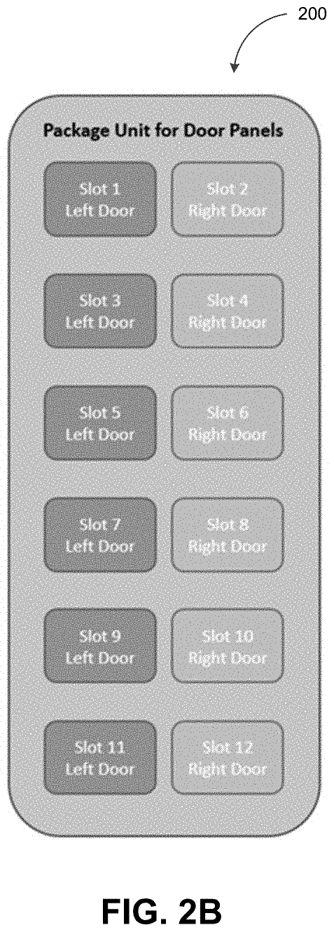

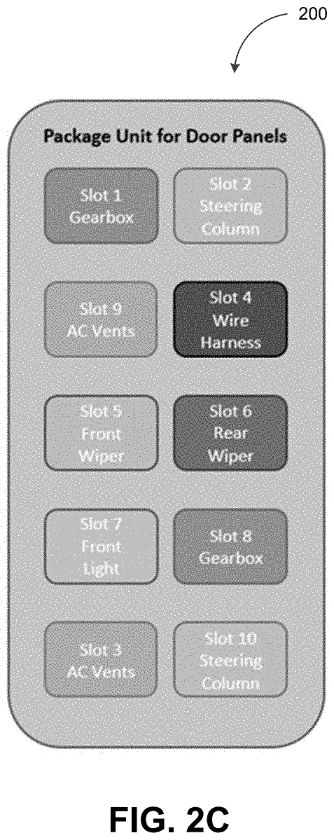

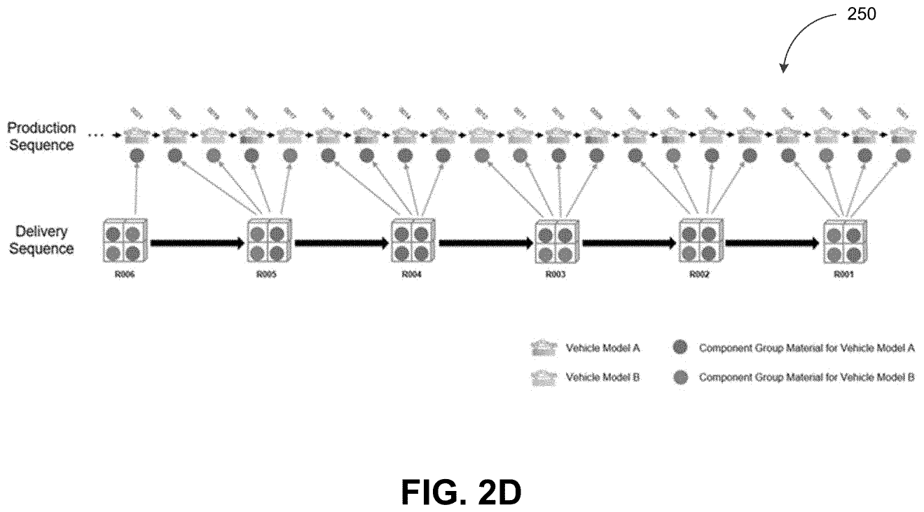

In some example embodiments, the packaging controller 110 impose an order for packaging items into a package unit including multiple slots, each of which being configured to receive a particular item. To further illustrate, FIG. 2A depicts a schematic diagram illustrating an example of a package unit 200, in accordance with some example embodiments. As shown in FIG. 2A, the package unit 200 may include eight slots (e.g., Slot 1 through Slot 8), with each slot being associated with an identifier. Moreover, the package unit 200 may be associated with a packing order 135, which the packaging controller 110 may retrieve, for example, from the data store 130, based on an identifier associated with the package unit 200. Accordingly, upon receiving, from the scanning device 120, a scan of a first identifier 125a associated with Slot 4, the packaging controller 110 may determine, based at least on the first identifier 125a and the packing order 135, the item that is to be disposed within Slot 4. Similarly, upon receiving, from the scanning device 120, a scan of a second identifier 125b associated with Slot 8, the packaging controller 110 may determine, based at least on the second identifier 125b and the packing order 135, the item that is to be disposed within Slot 8.

FIG. 2B depicts another example of the package unit 200 having twelve slots. Referring to FIG. 2B, the odd numbered slots in the example of the package unit 200 shown in FIG. 2B are configured to receive components for a left door panel of an automobile while the even numbered slots are configured to receive components for a right door panel of an automobile. In the example of the package unit 200 shown in FIG. 2C, each of the ten slots are configured to receive a specific door panel component. For example, Slot 1 is configured to receive the gearbox while Slot 2 is configured to receive the steering column. Accordingly, upon receiving, from the scanning device 120, a first identifier associated with Slot 1, the packaging controller 110 may generate a user interface identifying the gearbox as the item to be disposed within Slot 1. Alternatively, the packaging controller 110 may receive, from the scanning device 120, a second identifier associated with the gearbox, in which case the packaging controller 110 may generate the user interface to identify Slot 1 for disposing the gearbox.

In some example embodiments, by imposing a specific order for packaging items into the package unit 200, the packaging controller 110 may ensure that the items are packed in an order that is consistent with a subsequent unpacking sequence, delivery sequence, and/or production sequence associated with the package unit 200. For instance, FIG. 2D depicts an example of a production sequence 250 at an automobile manufacturing facility. As shown in FIG. 2D, the packing order 135 of the package unit 200, which contain components for Vehicle Model A and Vehicle Model B, may correspond to the sequence in which the individual components in the package unit 200 are unpacked and delivered during the production sequence of Vehicle Model A and Vehicle Model B. Packaging components in the order in which the components are used during the production of Vehicle Model A and Vehicle Model B may reduce inventory and increase production efficiency.

In some example embodiments, the packaging controller 110 may support different packing strategies including, for example, a material-by-material packing strategy, a slot-by-slot packing strategy, and/or the like. When a slot-by-slot packing strategy is selected, the packaging controller 110 may respond to receiving, from the scanning device 120, a first scan of a first identifier of a slot in the package unit 200 by at least identifying the item that is to be disposed inside the slot. Alternatively, when a material-by-material packing strategy is selected, the packaging controller 110 may respond to receiving, from the scanning device 120, a first scan of a first identifier of an item by at least identifying a slot in the package unit 200 for receiving the item.

In some example embodiments, the packaging controller 110 may verify a match between item and slot. For example, in the case of a slot-by-slot packing strategy, the packaging controller 110 may be further configured to determine whether a second identifier of an item captured in a second scan received from the scanning device 120 corresponds to the first identifier of the slot captured in the first scan received from the scanning device 120. That is, the packaging controller 110 may determine, based at least on the packing order 135, whether the second identifier of the item captured in the second scan matches that of the item that should be disposed within the slot having the first identifier captured in the first scan. With a material-by-material packing strategy, the packaging controller 110 may determine whether a second identifier of a slot captured in a second scan received from the scanning device 120 corresponds to the first identifier of the item captured in the first scan received from the scanning device 120. In this case, the packaging controller 110 may determine, based at least on the packing order 135, whether the second identifier of the slot captured in the second scan matches that of the slot configured to receive the item having the first identifier captured in the first scan.

In some example embodiments, a single identifier may convey one or more pieces of information. For example, the identifier associated with a slot within the package unit 200 may identify one or more of the slot itself, the packing order 135 for the package unit 200, and the item that is to be disposed within the slot. Alternatively and/or additionally, the identifier associated with an item may identify one or more of the item itself, the packing order 135 of the package unit 200 for receiving the item, and the slot configured to receive the item. Accordingly, the packaging controller 110 may determine, based on a single scan of an identifier, multiple pieces of information. For instance, the packaging controller 110 may determine, based on a scan of the identifier associated with a slot, one or more of the slot itself, the packing order 135 for the package unit 200, and the item that is to be disposed within the slot. Alternatively and/or additionally, the packaging controller 110 may determine, based on a scan of the identifier associated with an item, one or more of the item itself, the packing order 135 of the package unit 200 for receiving the item, and the slot configured to receive the item.

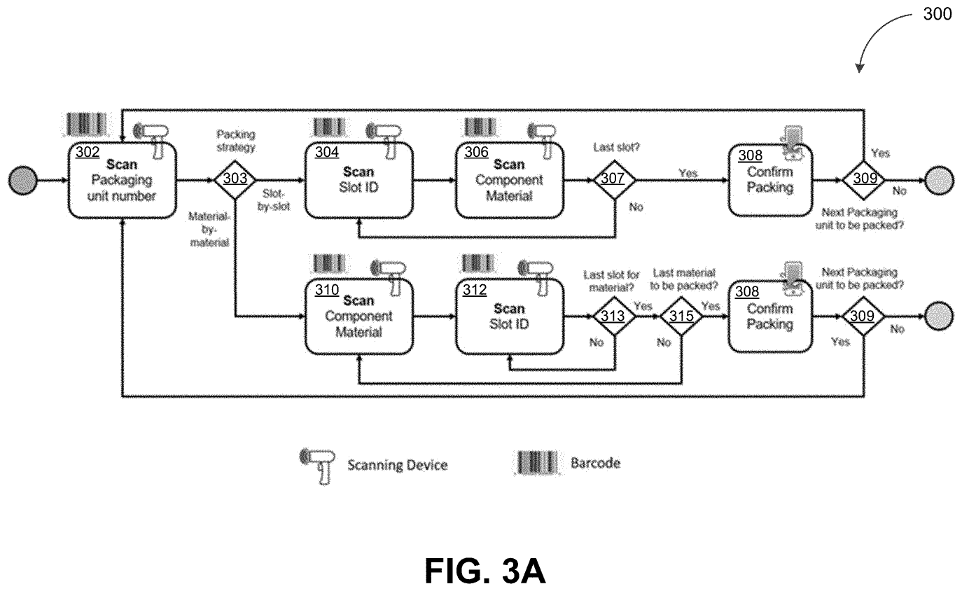

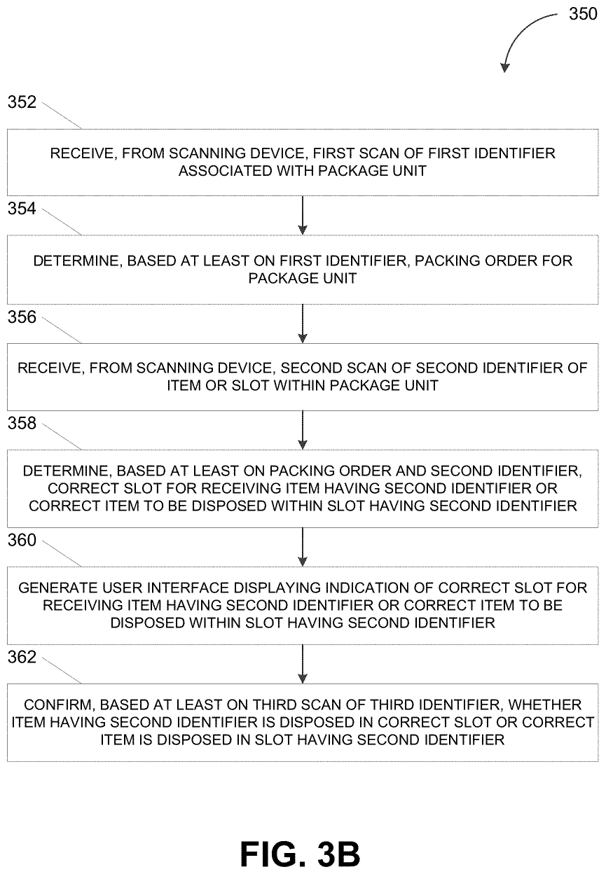

FIG. 3A depicts a flowchart illustrating an example of a process 300 for scan based packaging, in accordance with some example embodiments. Referring to FIG. 3A, at 302, the packaging controller 110 may receive, from the scanning device 120, a first scan of a first identifier of the package unit 200. As noted, the packaging controller 110 may determine, based at least on the first identifier of the package unit 200, the packing order 350. In some cases, the packaging controller 110 may retrieve, from the data store 130, the packing order 350 based at least on the first identifier of the package unit 200. Moreover, as noted, in addition to being associated with the package unit 200, the first identifier may be associated with one or more slots in the package unit 200 or one or more items to be disposed inside the package unit 200. As such, the packaging controller 110 may identify the packing order 350 for packing the package unit 200 based on a first scan of a first identifier of one or more slots in the package unit 200 or one or more items to be disposed in the package unit 200.

At 303, the packaging controller 110 may determine the packing strategy for packing the packaging unit 200. As noted, the packaging controller 110 may support different packing strategies including, for example, a material-by-material packing strategy, a slot-by-slot packing strategy, and/or the like. When a slot-by-slot packing strategy is selected, the packaging controller 110 may respond to receiving, from the scanning device 120, a first scan of a first identifier of a slot in the package unit 200 by at least identifying the item that is to be disposed inside the slot. Alternatively, when a material-by-material packing strategy is selected, the packaging controller 110 may respond to receiving, from the scanning device 120, a first scan of a first identifier of an item by at least identifying a slot in the package unit 200 for receiving the item. The packaging controller 110 may determine the packing strategy based on one or more user inputs received, for example, via the scanning device 120, selecting one of a slot-by-slot packing strategy or a material-by-material packing strategy.

Referring again to FIG. 3A, if the packaging controller 110 determines to implement a slot-by-slot packing strategy, at 304, the packaging controller 110 may receive a second scan of a second identifier of a slot within the package unit 200. In response to receiving the second scan of the second identifier of the slot within the package unit 200, the packaging controller 110 may determine, based at least on the second identifier and the packing order 135 for the package unit 200, the item to be disposed within the slot having the second identifier. The packaging controller 110 may provide an indication of the item to be disposed within the slot having the second identifier. For example, the packaging controller 110 may generate a user interface displaying at the scanning device 120 the indication of the item to be disposed within the slot having the second identifier.

In some cases, the packaging controller 110 may verify whether the correct item is disposed within the slot having the second identifier. For example, as shown in FIG. 3A, the packaging controller 110 may receive, from the scanning device 120, a third scan of a third identifier of the item disposed within the slot having the second identifier. The packaging controller 110 may generate a feedback indicative of whether the correct item is disposed within the slot having the second identifier. For instance, in response to the third identifier of the item disposed within the slot having the second identifier matching that of the item assigned to the slot by the packing order 135, the packaging controller 110 may generate a user interface displaying a confirmation and/or instructions prompting a scan of a subsequent slot in the package unit 200. Alternatively, the packaging controller 110 may generate a user interface displaying an error message if the third identifier of the item disposed within the slot having the second identifier does not match that of the item assigned to the slot by the packing order 135.

At 307, the packaging controller 110 may determine whether the a last slot in the package unit 200 has been filled. If additional slots in the package unit 200 remain to be filled, the process 300 may resume again at operation 304 where the packaging controller 110 receives a fourth scan of a fourth identifier of a remaining slot in the package unit 200. Alternatively, if no additional slots in the package unit 200 remain to be filled, the process 300 may continue at operation 308 where the packaging controller 110 confirms the packing of the package unit 200. At 309, the packaging controller 110 may determine whether additional package units requires packing. If additional package units remain, the process 300 may resume at operation 302 where the packaging controller 110 receives, from the scanning device 120, a fourth scan of a fourth identifier of a remaining package unit. Alternatively, if no additional package unit remain, the process 300 may terminate.

Referring again to FIG. 3A, in the event the packaging controller 110 implements a material-by-material packing strategy, at 310, the packaging controller 110 may receive, from the scanning device 120, a second scan of a second identifier of an item to be disposed within a slot of the package unit 200. In response to receiving the second scan of the second identifier of the item, the packaging controller 110 may determine, based at least on the second identifier and the packing order 135 for the package unit 200, the slot configured to receive the item having the second identifier. The packaging controller 110 may provide an indication of the slot for receiving the item having the second identifier. For example, the packaging controller 110 may generate a user interface displaying at the scanning device 120 the indication of the slot for receiving the item having the second identifier.

In some cases, the packaging controller 110 may verify whether the item having the second identifier is disposed within the correct slot in the package unit 200. For example, as shown in FIG. 3A, the packaging controller 110 may receive, from the scanning device 120, a third scan of a third identifier of the slot in which the item having the second identifier is disposed. The packaging controller 110 may generate a feedback indicative of whether the item having the second identifier is disposed within the correct slot. For instance, in response to the third identifier of the slot in which the item having the second identifier is disposed matching that of the slot assigned by the packing order 135 for receiving the item, the packaging controller 110 may generate a user interface displaying a confirmation and/or instructions prompting a scan of a subsequent item for packing into the package unit 200. Alternatively, the packaging controller 110 may generate a user interface displaying an error message if the third identifier of the slot in which the item having the second identifier is disposed does not match that of the slot assigned by the packing order 135 for receiving the item.

At 313, the packaging controller 110 may determine whether the a last slot for the same item in the package unit 200 has been filled. If additional slots in the package unit 200 remain to be filled with the same item, the process 300 may resume at operation 312 where the packaging controller 110 receives, from the scanning device 120, a fourth scan of a fourth identifier of another slot in which the item having the second identifier is disposed. Alternatively, if no additional slots in the package unit 200 remain to be filled with the same item, at 315, the packaging controller 110 may determine whether additional items are to be packaged into the package unit 200.

If additional items are to be packaged into the package unit 200, the process 300 may resume at operation 310 where the packaging controller 110 receives, from the scanning device 120, a fourth scan of a fourth identifier of another item to be disposed within a slot of the package unit 200. Alternatively, if no additional items are to be packaged into the package unit 200, the process 300 may continue at operation 308 where the packaging controller 110 confirms the packing of the package unit 200. At 309, the packaging controller 110 may determine whether additional package units requires packing. If additional package units remain, the process 300 may resume at operation 302 where the packaging controller 110 receives, from the scanning device 120, a fourth scan of a fourth identifier of a remaining package unit. Alternatively, if no additional package unit remain, the process 300 may terminate.

FIG. 3B depicts a flowchart illustrating another example of a process 350 for scan based packaging, in accordance with some example embodiments. Referring to FIGS. 1 and 3B, the process 350 may be performed by the packaging controller 110, for example, to impose the packing order 350 for packing the package unit 200.

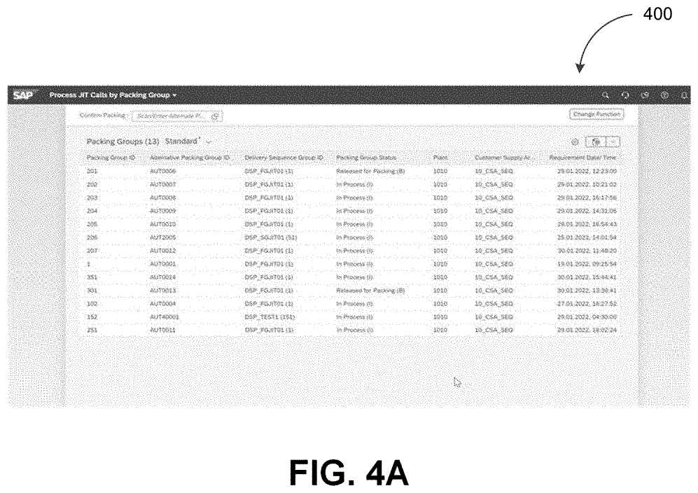

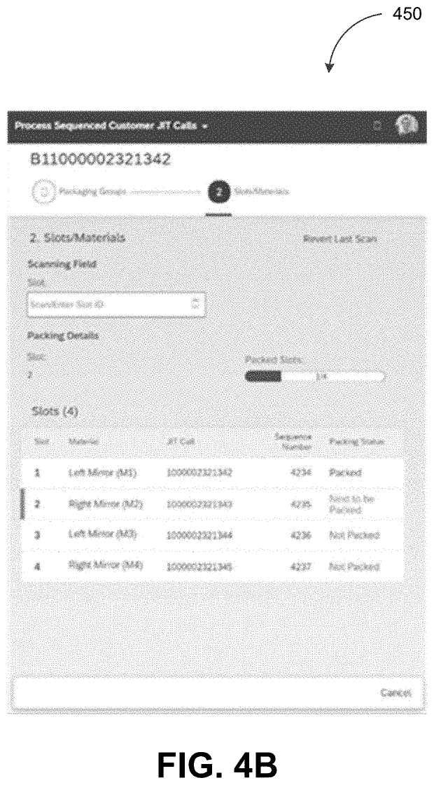

At 352, the packaging controller 110 may receive, from the scanning device 120, a first scan of a first identifier associated with a package unit. For example, the packaging controller 110 may receive, from the scanning device 120, a first scan of a first identifier associated with the package unit 200. FIG. 4A depicts a screenshot of an example of a user interface 400 associated with the packaging controller 110. As shown in FIG. 4A, the user interface 400 may be displayed, for example, at the scanning device 120, to prompt the scanning of one or more identifiers associated with the package unit 200, slots within the package unit 200, and/or items to be disposed within the package unit 200. Moreover, as shown in FIG. 4A, the user interface 400 may display, for each package unit in a list of package units, a corresponding identifier and packing progress.

At 354, the packaging controller 110 may determine, based at least on the first identifier, a packing order for the package unit. In some example embodiments, the packaging controller 110 may determine, based at least on the first identifier associated with the package unit 200, the packing order 135 for packing items into the package unit 200. In some cases, the packaging controller 110 may retrieve, from the data store 130, the packing order 350 based at least on the first identifier of the package unit 200. Moreover, as noted, in addition to being associated with the package unit 200, the first identifier may be associated with one or more slots in the package unit 200 or one or more items to be disposed inside the package unit 200. As such, the packaging controller 110 may identify the packing order 350 for packing the package unit 200 based on a first scan of a first identifier of one or more slots in the package unit 200 or one or more items to be disposed in the package unit 200.

At 356, the packaging controller 110 may receive, from the scanning device 120, a second scan of a second identifier of an item or a slot within the package unit. In some example embodiments, where the packaging controller 110 is implementing a slot-by-slot packing strategy, the packaging controller 110 may receive, from the scanning device 120, a second scan of a second identifier of a slot within the package unit 200. Alternatively, if the packaging controller 110 is implementing a material-by-material packing strategy, the packaging controller 110 may receive, from the scanning device 120, a second scan of a second identifier of an item to be disposed within a slot in the package unit 200.

At 358, the packaging controller 110 may determine, based at least on the packing order and the second identifier, a correct slot for receiving the item having the second identifier or a correct item to be disposed within the slot having the second identifier. In some example embodiments, where the packaging controller 110 is implementing a slot-by-slot packing strategy, the packaging controller 110 may determine, based at least on the packing order 135 and the second scan of the second identifier of the slot within the package unit 200, an item that is to be disposed within the slot having the second identifier. Alternatively, if the packaging controller 110 is implementing a material-by-material packing strategy, the packaging controller 110 may determine, based at least on the packing order 135 and the second scan of the second identifier of the item, a slot in the package unit 200 for receiving the item having the second identifier.

At 360, the packaging controller 110 may generate a user interface displaying an indication of the correct slot for receiving the item having the second identifier or the correct item to be disposed within the slot having the second identifier. For example, the packaging controller 110 may generate a user interface for displaying, at the scanning device 120, the item that is to be disposed within the slot having the second identifier or the slot in the package unit 200 for receiving the item having the second identifier. FIG. 4B depicts a screenshot of an example of a user interface 450 associated with the packaging controller 110. The user interface 450 may be displayed, for example, at the scanning device 120, to provide the progress for packing the package unit 200. Moreover, the example of the user interface 450 shown in FIG. 4B provides an indication of the next item or slot to be packed.

At 362, the packaging controller 110 may confirm, based at least on a third scan of a third identifier, whether the item having the second identifier is disposed in a correct slot or a correct item is disposed in the slot having the second identifier. In some example embodiments, where the packaging controller 110 is implementing a slot-by-slot packing strategy, the packaging controller 110 may verify whether the correct item is disposed within the slot having the second identifier. For example, in response to the third identifier of the item disposed within the slot having the second identifier matching that of the correct item, the packaging controller 110 may generate a user interface displaying a confirmation and/or instructions prompting a scan of a subsequent slot in the package unit 200. Alternatively, the packaging controller 110 may generate a user interface displaying an error message if the third identifier of the item disposed within the slot having the second identifier does not match that of the correct item.

In cases where the packaging controller 110 is implementing a material-by-material packing order, the packaging controller 110 may verify whether the item having the second identifier is disposed within the correct slot in the package unit 200. For example, in response to the third identifier of the slot in which the item having the second identifier is disposed matching that of the correct slot, the packaging controller 110 may generate a user interface displaying a confirmation and/or instructions prompting a scan of a subsequent item for packing into the package unit 200. Alternatively, the packaging controller 110 may generate a user interface displaying an error message if the third identifier of the slot in which the item having the second identifier is disposed does not match that of the correct slot.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

Example 2: The system of Example 1, wherein the operations further comprise: identifying, based at least the first identifier or a second identifier of the packaging unit included in a second scan received from the scanning device, the packing order for the package unit.

Example 3: The system of any one of Examples 1 to 2, wherein the operations further comprise: determining, based at least on one or more user inputs, a packing strategy for the package unit.

Example 4: The system of Example 3, wherein the operations further comprise: in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier.

Example 5: The system of Example 4, wherein the operations further comprise: receiving, from the scanning device, a second scan of a second identifier of a second item disposed within the first slot; determining, based at least on the packing order and the second identifier of the second item, whether the correct item is disposed within the first slot having the first identifier; and in response to the second item being an incorrect item for the first slot having the first identifier, updating the user interface to display an error message.

Example 6: The system of any one of Examples 3 to 5, wherein the operations further comprise: in response to the packing strategy being a material-by-material packing strategy, determining, based at least on the first identifier of the first item, the correct slot for receiving the first item having the first identifier, and generating the user interface to display the indication of the correct slot for receiving the first item having the first identifier.

Example 7: The system of Example 6, wherein the operations further comprise: receiving, from the scanning device, a second scan of a second identifier of a second slot in which the first item is disposed; determining, based at least on the packing order and the second identifier of the second slot, whether the first item having the first identifier is disposed within the correct slot; and in response to the first item having the first identifier being disposed with in an incorrect slot, updating the user interface to display an error message.

Example 8: The system of any one of Examples 6 to 7, wherein the operations further comprise: determining whether the package unit includes one or more additional slots for receiving a same item; and in response to the package unit including one or more additional slots for receiving the same item, receiving, from the scanning device, a second scan of a second identifier of a second item to be disposed within the package unit.

Example 9: The system of any one of Examples 1 to 8, wherein the first identifier comprises one or more of a Quick Response (QR) code, a stock keeping unit (SKU) code, a barcode, and a radio frequency identification (RFID) tag.

Example 10: The system of any one of Examples 1 to 9, wherein the scanning device comprises one or more of a barcode reader, a radio frequency identification (RFID) reader, a smartphone, a tablet computer, a wearable apparatus, a virtual assistant, and an Internet-of-Things (IoT) appliance.

Example 11: The system of any one of Examples 1 to 10, wherein the operations further comprise: in response to the correct item being disposed within the first slot having the first identifier or the first item being disposed within the correct slot, updating the user interface to provide an indication of a progress of packing the package unit.

Example 12: A computer-implemented method, comprising: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

Example 13: The method of Example 12, further comprising: identifying, based at least the first identifier or a second identifier of the packaging unit included in a second scan received from the scanning device, the packing order for the package unit.

Example 14: The method of any one of Examples 12 to 13, further comprising: determining, based at least on one or more user inputs, a packing strategy for the package unit.

Example 15: The method of Example 14, further comprising: in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier; receiving, from the scanning device, a second scan of a second identifier of a second item disposed within the first slot; determining, based at least on the packing order and the second identifier of the second item, whether the correct item is disposed within the first slot having the first identifier; and in response to the second item being an incorrect item for the first slot having the first identifier, updating the user interface to display an error message.

Example 16: The method of any one of Examples 14 to 15, further comprising: in response to the packing strategy being a material-by-material packing strategy, determining, based at least on the first identifier of the first item, the correct slot for receiving the first item having the first identifier, and generating the user interface to display the indication of the correct slot for receiving the first item having the first identifier; receiving, from the scanning device, a second scan of a second identifier of a second slot in which the first item is disposed; determining, based at least on the packing order and the second identifier of the second slot, whether the first item having the first identifier is disposed within the correct slot; and in response to the first item having the first identifier being disposed with in an incorrect slot, updating the user interface to display an error message.

Example 17: The method of Example 16, further comprising: determining whether the package unit includes one or more additional slots for receiving a same item; and in response to the package unit including one or more additional slots for receiving the same item, receiving, from the scanning device, a second scan of a second identifier of a second item to be disposed within the package unit.

Example 18: The method of any one of Examples 12 to 17, wherein the first identifier comprises one or more of a Quick Response (QR) code, a stock keeping unit (SKU) code, a barcode, and a radio frequency identification (RFID) tag, and wherein the scanning device comprises one or more of a barcode reader, a radio frequency identification (RFID) reader, a smartphone, a tablet computer, a wearable apparatus, a virtual assistant, and an Internet-of-Things (IoT) appliance.

Example 19: The method of any one of Examples 12 to 18, further comprising: in response to the correct item being disposed within the first slot having the first identifier or the first item being disposed within the correct slot, updating the user interface to provide an indication of a progress of packing the package unit.

Example 20: A non-transitory computer readable medium storing instructions, which when executed by at least one data processor, result in operations comprising: receiving, from a scanning device, a first scan of a first identifier of a first slot within a package unit or a first item to be disposed within the package unit; determining, based at least on the first identifier and a packing order associated with the package unit, a correct item to be disposed within the first slot having the first identifier or a correct slot for receiving the first item having the first identifier; and generating a user interface displaying an indication of the correct item to be disposed within the first slot having the first identifier or the correct slot for receiving the first item having the first identifier.

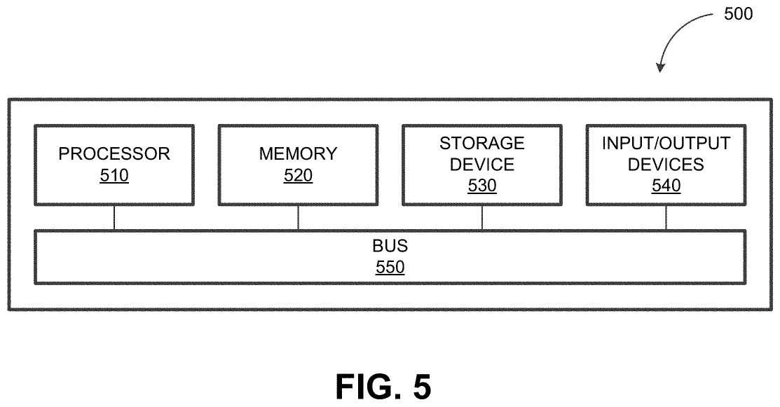

FIG. 5 depicts a block diagram illustrating a computing system 500, in accordance with some example embodiments. Referring to FIGS. 1-5, the computing system 500 can be used to implement the packaging controller 110, the processing engine 120, and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the packaging controller 110 and the processing engine 120. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions which, when executed by the at least one data processor, result in operations comprising:
receiving, from a scanning device, a first scan of a first identifier of a first slot within a package unit or a first item to be disposed within the package unit;
determining, based at least on the first identifier and a packing order associated with the package unit, a correct item to be disposed within the first slot having the first identifier or a correct slot for receiving the first item having the first identifier; and
generating a user interface displaying an indication of the correct item to be disposed within the first slot having the first identifier or the correct slot for receiving the first item having the first identifier.

2. The system of claim 1, wherein the operations further comprise:
identifying, based at least the first identifier or a second identifier of the packaging unit included in a second scan received from the scanning device, the packing order for the package unit.

3. The system of claim 1, wherein the operations further comprise:
determining, based at least on one or more user inputs, a packing strategy for the package unit.

4. The system of claim 3, wherein the operations further comprise:
in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier.

5. The system of claim 4, wherein the operations further comprise:
receiving, from the scanning device, a second scan of a second identifier of a second item disposed within the first slot;
determining, based at least on the packing order and the second identifier of the second item, whether the correct item is disposed within the first slot having the first identifier; and
in response to the second item being an incorrect item for the first slot having the first identifier, updating the user interface to display an error message.

6. The system of claim 3, wherein the operations further comprise:
in response to the packing strategy being a material-by-material packing strategy, determining, based at least on the first identifier of the first item, the correct slot for receiving the first item having the first identifier, and generating the user interface to display the indication of the correct slot for receiving the first item having the first identifier.

7. The system of claim 6, wherein the operations further comprise:
receiving, from the scanning device, a second scan of a second identifier of a second slot in which the first item is disposed;
determining, based at least on the packing order and the second identifier of the second slot, whether the first item having the first identifier is disposed within the correct slot; and
in response to the first item having the first identifier being disposed with in an incorrect slot, updating the user interface to display an error message.

8. The system of claim 6, wherein the operations further comprise:
determining whether the package unit includes one or more additional slots for receiving a same item; and
in response to the package unit including one or more additional slots for receiving the same item, receiving, from the scanning device, a second scan of a second identifier of a second item to be disposed within the package unit.

9. The system of claim 1, wherein the first identifier comprises one or more of a Quick Response (QR) code, a stock keeping unit (SKU) code, a barcode, and a radio frequency identification (RFID) tag.

10. The system of claim 1, wherein the scanning device comprises one or more of a barcode reader, a radio frequency identification (RFID) reader, a smartphone, a tablet computer, a wearable apparatus, a virtual assistant, and an Internet-of-Things (IoT) appliance.

11. The system of claim 1, wherein the operations further comprise:
in response to the correct item being disposed within the first slot having the first identifier or the first item being disposed within the correct slot, updating the user interface to provide an indication of a progress of packing the package unit.

12. A computer-implemented method, comprising:
receiving, from a scanning device, a first scan of a first identifier of a first slot within a package unit or a first item to be disposed within the package unit;
determining, based at least on the first identifier and a packing order associated with the package unit, a correct item to be disposed within the first slot having the first identifier or a correct slot for receiving the first item having the first identifier; and
generating a user interface displaying an indication of the correct item to be disposed within the first slot having the first identifier or the correct slot for receiving the first item having the first identifier.

13. The method of claim 12, further comprising:
identifying, based at least the first identifier or a second identifier of the packaging unit included in a second scan received from the scanning device, the packing order for the package unit.

14. The method of claim 12, further comprising:
determining, based at least on one or more user inputs, a packing strategy for the package unit.

15. The system of claim 14, further comprising:
in response to the packing strategy being a slot-by-slot packing strategy, determining, based at least on the first identifier of the first slot, the correct item to be disposed within the first slot having the first identifier, and generating the user interface to display the indication of the correct item to be disposed within the first slot having the first identifier;
receiving, from the scanning device, a second scan of a second identifier of a second item disposed within the first slot;
determining, based at least on the packing order and the second identifier of the second item, whether the correct item is disposed within the first slot having the first identifier; and
in response to the second item being an incorrect item for the first slot having the first identifier, updating the user interface to display an error message.

16. The method of claim 14, further comprising:
in response to the packing strategy being a material-by-material packing strategy, determining, based at least on the first identifier of the first item, the correct slot for receiving the first item having the first identifier, and generating the user interface to display the indication of the correct slot for receiving the first item having the first identifier;
receiving, from the scanning device, a second scan of a second identifier of a second slot in which the first item is disposed;
determining, based at least on the packing order and the second identifier of the second slot, whether the first item having the first identifier is disposed within the correct slot; and
in response to the first item having the first identifier being disposed with in an incorrect slot, updating the user interface to display an error message.

17. The method of claim 16, further comprising:
determining whether the package unit includes one or more additional slots for receiving a same item; and
in response to the package unit including one or more additional slots for receiving the same item, receiving, from the scanning device, a second scan of a second identifier of a second item to be disposed within the package unit.

18. The method of claim 12, wherein the first identifier comprises one or more of a Quick Response (QR) code, a stock keeping unit (SKU) code, a barcode, and a radio frequency identification (RFID) tag, and wherein the scanning device comprises one or more of a barcode reader, a radio frequency identification (RFID) reader, a smartphone, a tablet computer, a wearable apparatus, a virtual assistant, and an Internet-of-Things (IoT) appliance.

19. The method of claim 12, further comprising:
in response to the correct item being disposed within the first slot having the first identifier or the first item being disposed within the correct slot, updating the user interface to provide an indication of a progress of packing the package unit.

20. A non-transitory computer readable medium storing instructions, which when executed by at least one data processor, result in operations comprising:
receiving, from a scanning device, a first scan of a first identifier of a first slot within a package unit or a first item to be disposed within the package unit;
determining, based at least on the first identifier and a packing order associated with the package unit, a correct item to be disposed within the first slot having the first identifier or a correct slot for receiving the first item having the first identifier; and
generating a user interface displaying an indication of the correct item to be disposed within the first slot having the first identifier or the correct slot for receiving the first item having the first identifier.
